(19) United States
(12) Patent Application Publication
(10) Pub. No.: US 2018/0034408 A1
(43) Pub. Date: Feb. 1, 2018

(54) EDGE PROTECTION FOR A FLOATING PHOTOVOLTAIC POWER GENERATION SYSTEM

(71) Applicant: X Development LLC, Mountain View, CA (US)

(72) Inventors: Dominico Julian, Oakland, CA (US); Philipp H. Schmaelzle, Mountain View, CA (US); Todd A. Pelman, Moss Beach, CA (US); Thomas P. Hunt, Oakland, CA (US); Robert Baikie, San Francisco, CA (US); Mark Greise, Santa Ynez, CA (US)

(21) Appl. No.: 15/264,184

(22) Filed: Sep. 13, 2016

Related U.S. Application Data
(60) Provisional application No. 62/368,745, filed on Jul. 29, 2016.

(51) Int. Cl. H02S 30/10; B63B 35/44; H02S 20/30

(52) U.S. Cl. CPC H02S 30/10; H02S 20/30; B63B 35/44; B63B 2035/4453

(57) ABSTRACT

An edge protection member for positioning in a waterbody adjacent to a plurality of photovoltaic (“PV”) modules of a PV array that floats on the waterbody to protect the PV array from external forces includes a surface barrier. The surface barrier blocks flotsam on a water surface of the waterbody from floating into the PV array.

### CROSS-REFERENCE TO RELATED APPLICATION

This application claims the benefit of U.S. Provisional Application No. 62/368,745 filed on Jul. 29, 2016, the contents of which are incorporated herein by reference.

### TECHNICAL FIELD

This disclosure relates generally to solar power generation, and in particular but not exclusively, relates to floating solar power generation.

### BACKGROUND INFORMATION

As societies continue to industrialize throughout the world, the demand for affordable and plentiful electricity continues to grow. Renewable sources of electricity are increasingly being relied upon to meet this ever growing demand. One popular renewable source of electricity is solar power generation.

The construction of solar power plants is expensive and labor intensive. Each solar power module must be mechanically supported and electrically connected. Additionally, solar power plants may consume acres of otherwise usable land. A solar power module that can be economically fabricated, that is quickly, efficiently, and safely deployable in areas that are otherwise not being used, would be desirable and likely increase the adoption rate of commercial scale solar power generation.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 is a functional block diagram illustrating a floating photovoltaic (“PV”) power generation system, in accordance with an embodiment of the disclosure.

FIG. 2 is an illustration of a floating PV power generation system showing details of a mooring assembly and edge protection members, in accordance with an embodiment of the disclosure.

FIGS. 3A and 3B illustrate different views of a portion of an edge protection member, in accordance with an embodiment of the disclosure.

FIG. 3C illustrates two edge protection members disposed along adjacent sides of a PV array, in accordance with an embodiment of the disclosure.

FIG. 4A is a profile illustration of a first implementation of an edge protection member, in accordance with an embodiment of the disclosure.

FIG. 4B is a profile illustration of a second implementation of an edge protection member, in accordance with an embodiment of the disclosure.

FIG. 4C is a profile illustration of a third implementation of an edge protection member, in accordance with an embodiment of the disclosure.

FIG. 4D is a profile illustration of a fourth implementation of an edge protection member, in accordance with an embodiment of the disclosure.

FIG. 4E is a profile illustration of a fifth implementation of an edge protection member, in accordance with an embodiment of the disclosure.

FIG. 4F is a profile illustration of a sixth implementation of an edge protection member, in accordance with an embodiment of the disclosure.

FIG. 5 is functional block illustrations of a PV module, in accordance with an embodiment of the disclosure.

FIG. 6 is a cross-sectional view illustrating various materials layers of a PV module, in accordance with an embodiment of the disclosure.

### DETAILED DESCRIPTION

Embodiments of a system and an apparatus for edge protection of a floating photovoltaic (“PV”) power generation system are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

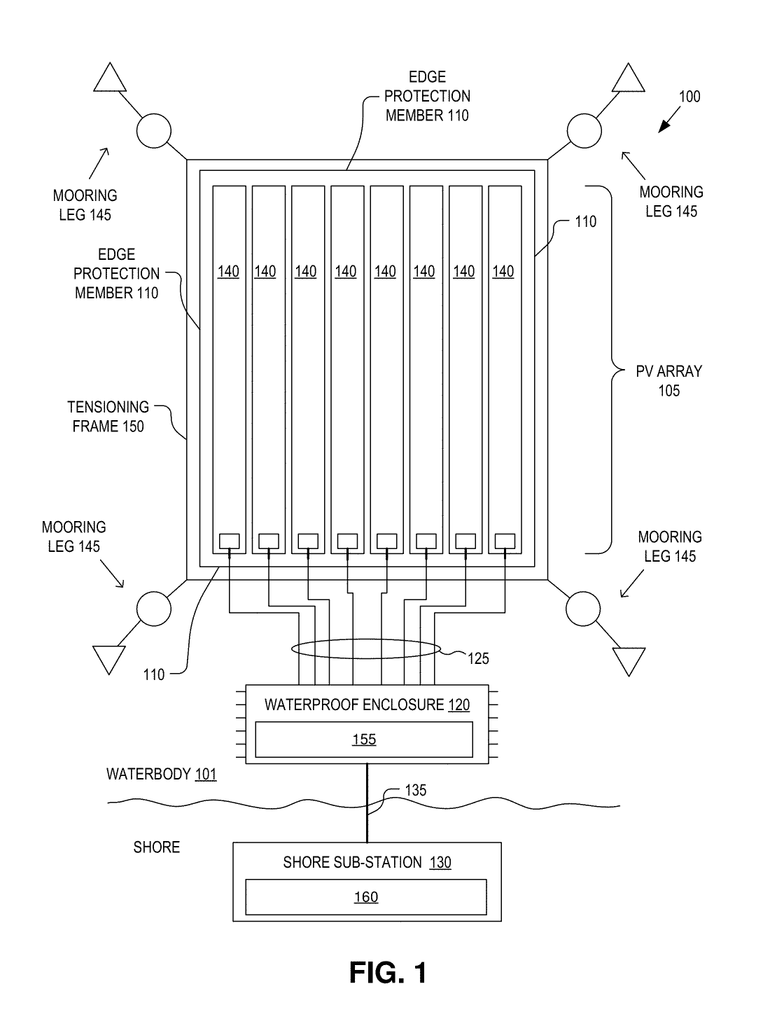

FIG. 1 is a block diagram illustrating components of a floating PV power generation system 100, in accordance with an embodiment of the disclosure. The illustrated embodiment of PV power generation system 100 includes a PV array 105, edge protection members 110, a mooring assembly, a waterproof enclosure 120, an electrical interconnect assembly 125, a shore substation 130, and a shore power cable 135. The illustrated embodiment of PV array 105 includes PV modules 140. The illustrated embodiment of the mooring assembly includes mooring legs 145 and tensioning frame 150. The illustrated embodiment of waterproof enclosure 120 houses electronics 155 while shore substation 130 includes electronics 160.

PV power generation system 100 is a solar power generation system that floats on waterbodies, such as reservoirs, lakes, or even protected coastal waters, though reservoirs may be the most suitable locations for a variety of reasons. For instance, reservoirs are typically shallow protected waterbodies. Floating solar power generation can compare favorably to land-based solar power generation systems because the surface of reservoirs often represents unused or underused space. In contrast, land-based solar power generation systems often compete with agricultural uses. Inherent attributes of a water based deployment can be leveraged for effective cooling that increases operational efficiency, extends expected service lifespans, and otherwise increases a return on investment (“ROI”) for a commercial-scale power generation system. Additionally, floating solar power systems, such as PV power generation system 100, reduces water evaporation, which is an important benefit for many reservoirs.

During operation, PV power generation system 100 is moored in a waterbody 101 and coupled to deliver solar power to shore substation 130 disposed on a shore of waterbody 101. Shore substation 130 may be coupled to deliver the solar power to a power grid or directly coupled to a local community or nearby facility (e.g., factory). PV array 105 includes a number of PV modules 140 mechanically bound together to form a contiguous block or array of PV modules 140. Each PV module 140 may be implemented as mat-like laminated structure (e.g., see FIG. 11), a chain of rigid solar panels linked together and disposed over one or more flotation structures, or other floating solar panel structures. While PV power generation system 100 can be deployed with a variable number of PV modules 140, which may each have a variety of different sizes, in one embodiment, each PV module 140 is 100 m long by 2 m wide and outputs 20 kW. In one embodiment, 50 PV modules 140 are connected to form a square contiguous PV array 105 having an overall power generation of 1 MW. Of course, PV arrays 105 having larger or smaller individual PV modules 140 and/or having a greater or smaller number of connected PV modules 140 may be implemented. FIG. 1 illustrates just eight PV modules 140 included within PV array 105 for simplicity of illustration.

Each PV module 140 includes solar cells connected in series and/or parallel in one or more solar cell strings to generate solar power. The solar cells are embedded within a laminated structure forming a sort of floating solar mat, which is compliant to folding or bending in response to wave action on a surface of waterbody 101. Since PV modules 140 use their buoyancy to float on or near the surface of waterbody 101, extensive (and often expensive) support housings and infrastructure that typify land based solar power systems are not necessary. By floating PV modules 140 on or near the surface of waterbody 101, PV modules 140 intimately contact the water for inherent heat dissipation and thermal cooling.

In the illustrated embodiment, PV array 105 is held in place by the mooring assembly, which includes mooring legs 145 and tensioning frame 150. Tensioning frame 150 maintains tension on PV array 105 to ensure the individual PV modules 140 do not tangle or otherwise experience compression that could damage PV modules 140. Tensioning frame 150 is tethered to mooring legs 145 so that the overall PV array 105 maintains a desired location within waterbody 101. Mooring legs 145 may be anchored to a bottom of the waterbody using various types of anchors (e.g., gravity anchor, embedment anchor, etc.). Each mooring leg 145 may include an anchor, an anchor line, and a buoy.

The illustrated embodiment of PV power generation system 100 further includes edge protection members 110 that extend around one or more sides (e.g., all sides in the embodiment of FIG. 1) of PV array 105 to protect PV modules 140 from floating debris (flotsam) in waterbody 101. In the illustrated embodiment, edge protection members 110 are disposed between tensioning frame 150 and PV array 105 and also serve as a mechanical intermediary between tensioning frame 150 and PV array 105. In one embodiment, edge protection members 110 further serve as a wind block to prevent (or otherwise reduce the incidence of) wind getting under the edges of PV array 105 and lifting portions of PV array 105 off the surface of the waterbody in high wind conditions. Edge protection members 110 also server to reduce an incidence or amplitude of waves overtopping PV array 105.

PV modules 140 are electrically coupled to the functional units housed within waterproof enclosure 120 via electrical interconnect assembly 125. In one embodiment, electrical interconnection assembly 125 is a waterproof wiring harness having individual power leads of variable length that match the variable distances between waterproof enclosure 120 and the connection points on PV modules 140. A single wiring harness allows for a quick and organized deployment in the field. In various embodiments, the connection points on PV modules 140 may include pigtail connections or socket connections mounted to a junction box integrated into one end of PV modules 140.

Waterproof enclosure 120 houses various electronics 155 that facilitate the operation of PV array 105. For example, electronics 155 may include a power combiner, a controller, a monitoring system, communication adapters, etc. Waterproof enclosure 120 is placed in the waterbody and provides environmental protection to these internal components and in particular provides thermal heat dissipation to the surrounding water for the power electronics disposed therein. In one embodiment, waterproof enclosure is a metal enclosure (e.g., aluminum) that dissipates heat via convection to the surrounding water. A power combiner within waterproof enclosure 120 operates to combine the solar power generated by PV modules 140 to which it is connected and may be implemented as a DC-to-DC power converter or DC-to-AC power inverter that steps up the voltage output from PV modules 140 for transport to shore substation 130 over shore power cable 135. A monitoring system and controller within waterproof enclosure 120 may be provided to monitor for upstream and/or downstream fault conditions, to sense various operational signals (e.g., power up or power down signals), and otherwise control various operational characteristics of PV array 105. Communication adapters within waterproof enclosure 120 facilitate data communications between shore substation 130 and PV modules 140 over shore power cable 135 and electrical interconnect assembly 125.

Electronics 160 of shore substation 130 include a power converter that steps up the voltage of the power received over shore power cable 135 to a grid-level voltage. This power converter may also isolate the grid from any faults in PV power generation system 100. Electronics 160 can also include a controller and communication circuitry to choreograph the operation of other functional elements within the system. In one embodiment, electronics 160 includes a DC-to-AC power inverter.

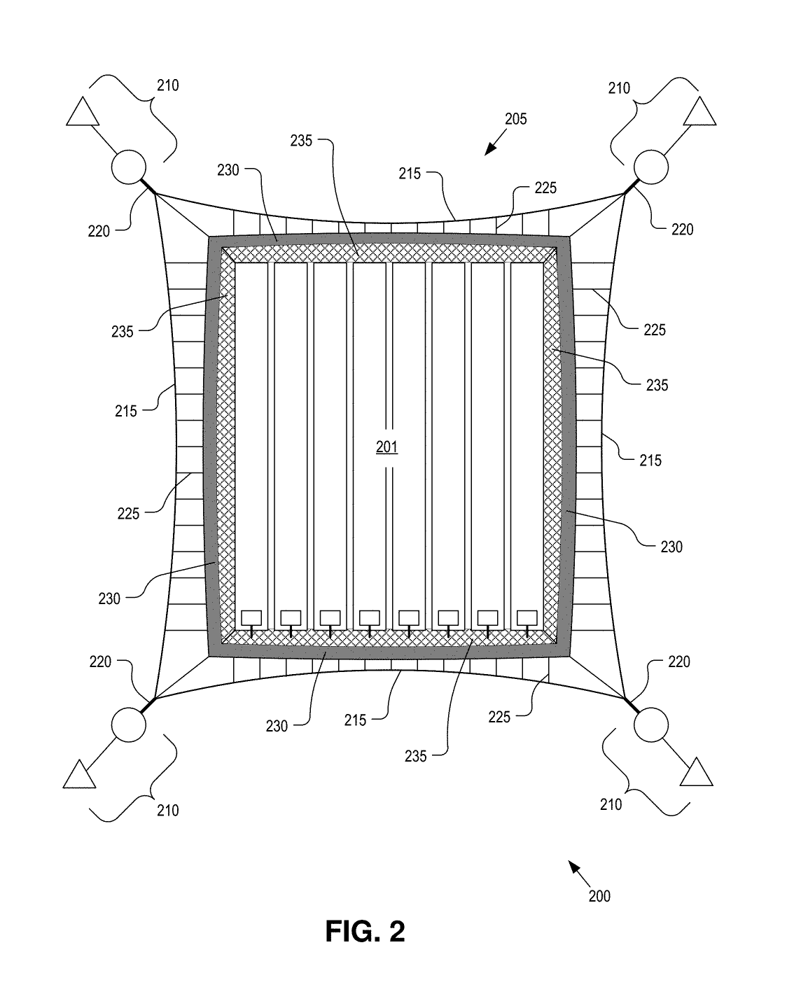

FIG. 2 illustrates details of a mooring assembly and edge protection members of a floating PV power generation system 200, in accordance with an embodiment of the disclosure. PV power generation system 200 is one possible implementation of PV power generation system 100; however, certain components (e.g., waterproof enclosure, electrical interconnect assembly, shore power cable, shore substation, etc.) have been omitted from FIG. 2 so as not to clutter the drawing. The illustrated embodiment of the mooring assembly includes a tensioning frame 205 and mooring legs 210. The illustrated embodiment of tensioning frame 205 includes main lines 215, adjustable tensioning tethers 220, and tension lines 225. The illustrated embodiment of the edge protection members includes surface barrier sections 230 and PV array connectors 235.

Tensioning frame 205 serves as a connection between mooring legs 210 and PV array 201. Tensioning frame 205 maintains tension on the PV modules of PV array 201 to prevent, or at least reduce a likelihood of, them experiencing compression buckling or twisting that damages the PV modules. In the illustrated embodiment, tensioning frame 205 physically connects to surface barrier sections 230 while PV array connectors 235 translate the tensile force to PV array 201. In other embodiments, tensioning frame 205 may couple directly to PV array 201. In one embodiment, surface barrier sections 230 are disposed along the outside perimeter of main lines 215 (not illustrated).

Mainlines 215 are support lines extending between mooring legs 210. Mainlines 215 form an arc between their connecting mooring legs 210, which maintains tension on tension lines 225. Tension lines 225 extend between the mainlines 215 and surface barrier sections 230 and serve to apply tensile forces around the sides of PV array 201. In the illustrated embodiment, tension lines 225 exerted a tensile force onto the outer sides of surface barrier sections 230, which in turn translate the tensile force to PV array 201 via PV array connectors 235. In other embodiments, tension lines 225 may connect directly to the PV modules by passing through or over surface barrier sections 230. Tensioning frame 205 may be formed as a rope rigging. For example, tensioning frame 205 may be fabricated of a low weight, stretch resistant, UV stable line. In one embodiment, tensioning frame 205 is a sheathed polymer line.

Adjustable tensioning tethers 220 provide a mechanism for adjusting the tension on tensioning frame 205 by adjusting their lengths. For example, each adjustable tensioning tether 220 may be implemented as a pulley assembly (e.g., block and tackle) with a lock, replaceable tethers of variable lengths, cinch-tight straps, or otherwise. Adjustable tensioning tethers 220 allow the system to be deployed and interconnected while tensioning frame 205 is relaxed, then subsequently pulled taut to a desired tensile force to ensure PV array 201 is appropriately held in place. If tensioning frame 205 stretches after the initial deployment or a wind or wave storm, adjustable tensioning tethers 220 can readily be retightened as needed.

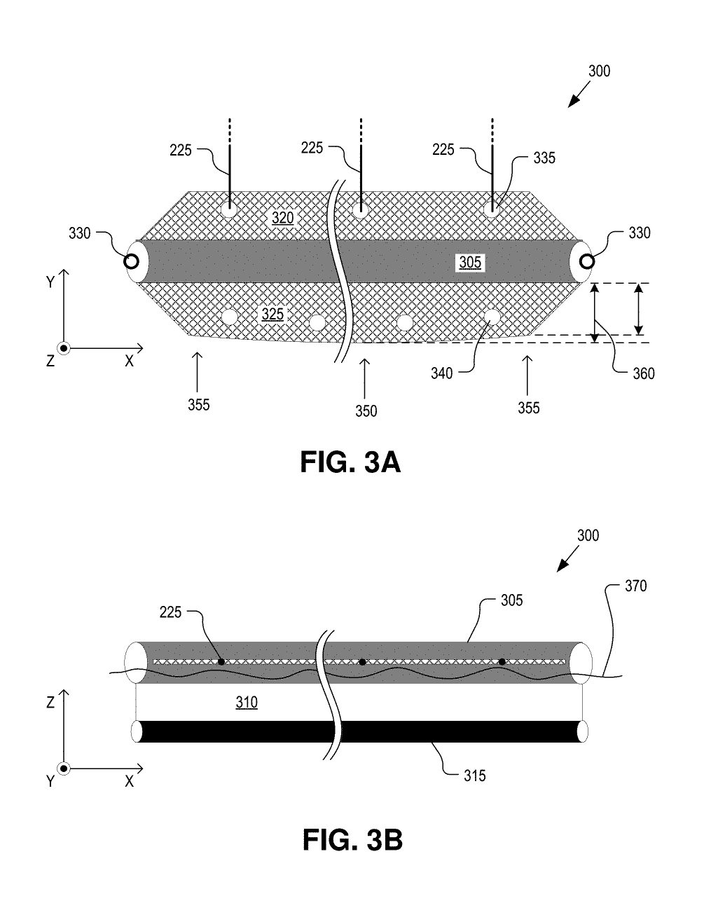

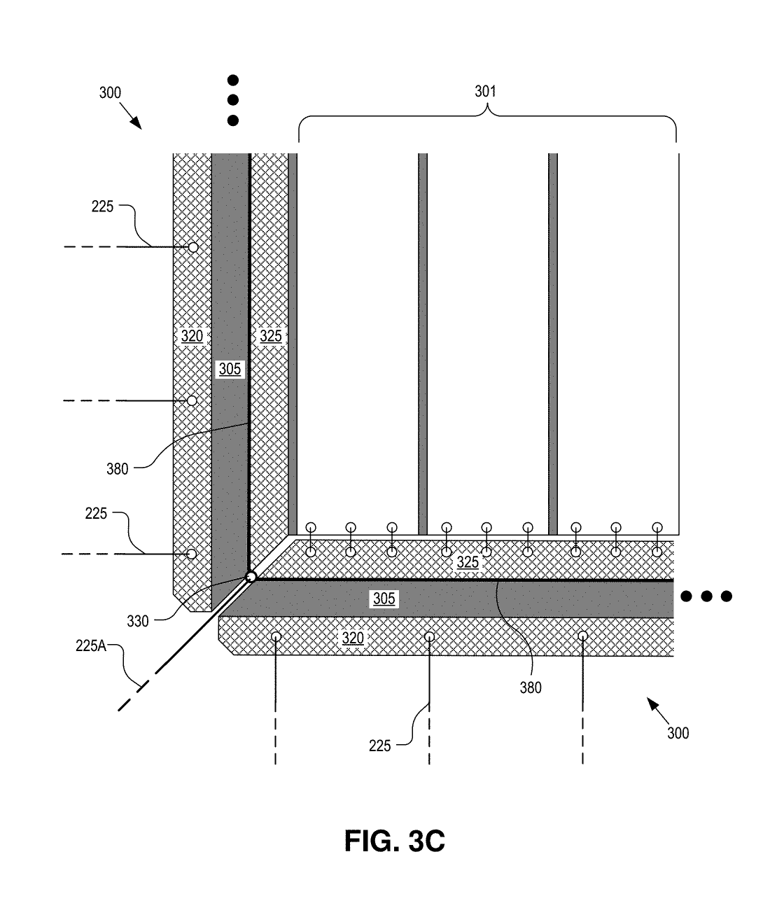

FIGS. 3A and 3B illustrate different views of a portion of an edge protection member 300, in accordance with an embodiment of the disclosure. Edge protection member 300 is one possible implementation of edge protection member 110 illustrated in FIG. 1. FIG. 3A is a plan view illustration of edge protection member 300 while FIG. 3B is a profile illustration of the same. The illustrated embodiment of edge protection member 300 includes a surface barrier 305, a wind barrier 310, a ballast 315, a tension frame connector 320, a PV array connector 325, and longitudinal connectors 330. The illustrated embodiment of tension frame connector 320 includes eyeholes 335. The illustrated embodiment of PV array connector 325 includes eyeholes 340.

When deployed, surface barrier 305 resided along water surface 370 adjacent to a side of the PV array to protect the PV array from external forces. These external forces may include flotsam (debris floating on water surface 370 such as logs or branches), wind, waves, animals, or otherwise. It operates as a physical barrier having a freeboard to block or otherwise reduce the encroachment of external forces onto the PV array. In one embodiment, surface barrier 305 has sufficient buoyancy to maintain a freeboard at water surface 370, which resists water currents from pushing it or the PV array underwater. In various embodiments, surface barrier 305 may be implemented as a single elongated float, or a series of end-to-end connected elongated floats that extend along an entire length of at least one side of the PV array. Multiple surface barriers 305 may be linked to partially or entirely encircle the PV array for multisided protection.

In the illustrated embodiment, surface barrier 305 has a circular cross-sectional shape. However, surface barrier 305 may assume a variety of other cross-sectional shapes including rectangular, pentagonal, hexagonal, etc. Furthermore, surface barrier 305 may be fabricated of multiple components bound together. Example implementations of surface barrier 305 include an inflatable float, a solid core float (e.g., foam core), a rigid body air cavity float (e.g., a hollow plastic or metal pontoon).

In the illustrated embodiment, tension lines 225 exerted a tensile force onto tension frame connector 320, which in turn translates the tensile force through surface barrier 305 and PV array connector 325 to the PV array. In the illustrated embodiment, PV array connector 325 is a fabric tab/flap with eyeholes 340 (e.g., grommets) that are lashed (or otherwise mechanically connected) to outer edges of those PV modules that fall along the perimeter of the PV array. Other mechanical connections than eyeholes 340 may be used (e.g., straps, buckles, clips, snaps, hook and loop connectors, quick ties, zipper, etc.). Tension frame connector 320 may be fabricated in a similar manner using similar materials.

Tension frame connector 320 is disposed along surface barrier 305 for applying outward tension on edge protection member 300 to pull edge protection member 300 away from the PV array when deployed in a waterbody. PV array connector 325 is disposed along an opposite side of surface barrier 305 to translate the outward tension to the PV array to also place the PV array under tension when deployed. In one embodiment, PV array connector 325 is flexible and collapses in compression to prevent the application of a deleterious compressive force on the PV array. In the illustrated embodiment, PV array connector 325 is wider in a middle portion 350 of edge protection member 300 than compared to peripheral portions 355 to provide a larger standoff distance 360 between surface barrier 305 and the PV array in middle portion 350 than peripheral portions 355. The larger standoff distance 360 provides greater protection in the middle portion 350 against collisions where the outward tensile force asserted by the tension frame and tension lines 225 is typically less.

FIG. 3B illustrates how wind barrier 310 connects to surface barrier 305 and extends below water surface 370 when edge protection member 300 is positioned in a waterbody. Wind barrier 310 creates a windscreen that extends down below water surface 370 even when surface barrier 305 is lifted off water surface 370 by high winds, wave action, or external loading. Wind barrier 310 reduces an incidence of the wind getting under adjacent portions of the PV array and lifting those portions off the waterbody. Wind barrier 310 may be fabricated of a variety of materials. For example, wind barrier 310 may be a flexible skirt (e.g., plastic, fabric, etc.) or a rigid skirt (e.g., plastic, metal, wood, composite, etc.).

Ballast 315 is connected to wind barrier 310 to provide a downward force help keep at least a portion of wind barrier 310 below water surface 370 despite a limited amount of liftoff of surface barrier 310 from water surface 370 in high winds, waves, or external loading. In the illustrated embodiment, wind barrier 310 connects to a bottom side of surface barrier 305 and ballast 315 connects to a bottom side of wind barrier 310. Ballast 315 may be a distinct weight that is attached to wind barrier 310 or an integral weight that is incorporated into wind barrier 310. For example, ballast 315 may be implemented as a solid core weight (e.g., metal, rock, concrete, chain, cable, etc.), a granular fill material (e.g., sand, pebbles, etc.), or water ballast (e.g., water filled enclosure).

FIG. 3C illustrates an example of how two edge protection members 300 may be disposed along adjacent sides of a PV array 301, in accordance with an embodiment of the disclosure. In the illustrated, tension lines 225 apply an outward tension on tension frame connector 320, which is translated to PV array 301 via surface barrier 305 and PV array connector 325. Edge protection members 300 are interconnected at their distal ends via longitudinal connectors 330. Longitudinal connector 330 applies a longitudinal tension down the length of edge protection members 300 via the corner tension line 225A. In one embodiment, longitudinal connector 330 connects to a longitudinal line 380 that extends along the length of edge protection members 300 to carry the longitudinal tension force. In one embodiment, both longitudinal connector 330 and longitudinal line 380 are fabricated of conductive material (e.g., metallic). In this conductive embodiment, longitudinal connector 330 and longitudinal line 380 also operate collectively as a perimeter guard ring that encircles PV array 301. This perimeter guard ring is electrically grounded and blocks electrical arcing, in the event of failure of a PV module, between PV array 301 and an item (e.g., person) external to edge protection members 300. The perimeter guard ring may be grounded to the waterbody, to the ground below the waterbody via the mooring assembly, or to shore via a ground line. In alternative embodiments, one or more independent guard rings that are not mechanical structures for carrying tension forces may be used.

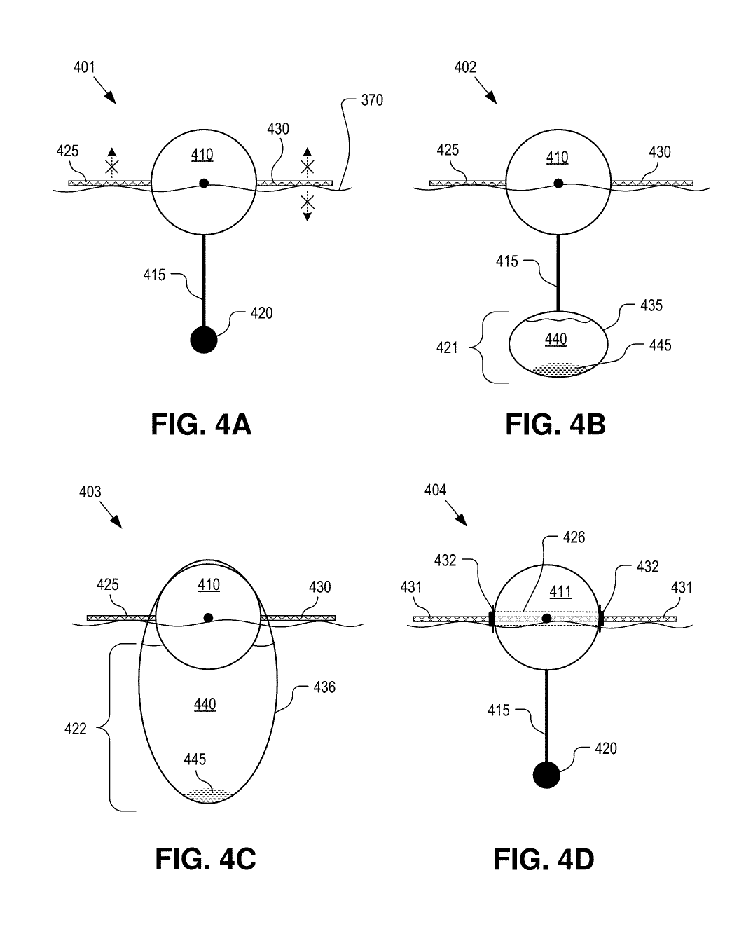

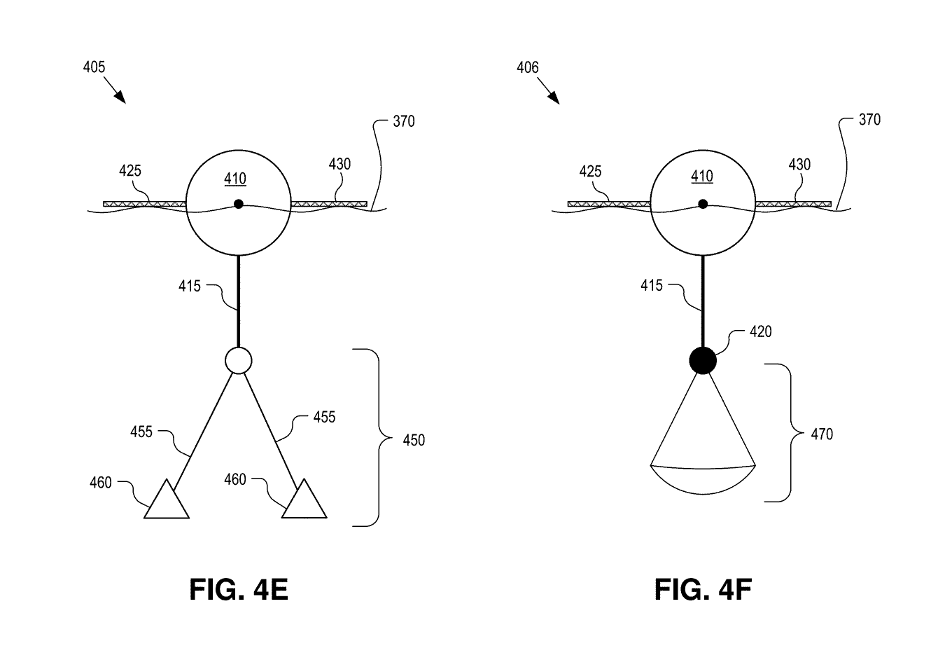

FIGS. 4A-4F are profile illustrations of various alternative implementations of edge protection members 110. These implementations are not intended to be exhaustive and it should further be appreciated features of the various implementations may be mixed and matched to provide hybrid implementations.

FIG. 4A illustrates a first edge protection member 401 including a surface barrier 410, a wind barrier 415, a ballast 420, a tension frame connector 425, and a PV array connector 430. Edge protection member 401 is similar to edge protection member 300 where wind barrier 415 is a flexible skirt attached to the bottom side of surface barrier 410 and weighed down by ballast 420. Ballast 420 is a solid core weight (e.g., a metal rod) attached to the bottom side of wind barrier 415.

FIG. 4A also illustrates how PV array connector 430 mounts to a side of surface barrier 410 at a vertical position that substantially does not apply a vertical force on the PV array and neither lifts the PV array up off water surface 370 nor submerges the PV array down below water surface 370. Lifting a side edge of the PV array allows deleterious air pockets to get trapped under the PV array, which can be thermally insulating. Submerging the side edges of the PV array can cause water to pool on the PV array thereby reducing solar efficiency. In one embodiment, tension frame connector 425 also mounts to a side of surface barrier 410 at a vertical position that substantially does not apply a vertical force on the PV array that lifts the surface barrier 410 off water surface 370. In one embodiment, both tension frame connector 425 and PV array connector 430 are mounted at vertical heights on surface barrier 410 that do not apply substantial vertical tension forces on surface barrier 410 or the PV array.

FIG. 4B illustrates a second edge protection member 402 including surface barrier 410, wind barrier 415, a ballast 421, tension frame connector 425, and PV array connector 430. Edge protection member 402 is similar to edge protection member 401 except that ballast 421 is an enclosure 435 filled with water 440 as ballast (e.g., water sack). Enclosure 435 optionally includes weight material 445 for additional ballast. Enclosure 435 may be implemented as a rigid enclosure or a flexible enclosure. Enclosure 435 may be sealed enclosure or a non-fully enclosed, slow draining chamber. Weight material 445 may be a variety of materials such as metal weights (e.g., chain, cable, etc.), sand, pebbles, rocks, or otherwise.

FIG. 4C illustrates a third edge protection member 403 including surface barrier 410, an enclosure 436, a ballast 422, tension frame connector 425, and PV array connector 430. Edge protection member 403 is similar to edge protection member 402 except that enclosure 436 performs dual functions of both wind barrier and ballast. When enclosure 436 is lifted up, the sides of enclosure 436 perform the wind barrier function. Additionally, enclosure 436 is filled with water 440 and optionally weight material 445, thereby also functioning as a ballast 422 to keep the enclosure 436 from lifting above the water surface. Ballast 422 provides a downward restoring force that proportionally increases with the distance that ballast 422 is lifted out of the water. In other words, as surface barrier 410 is lifted up, ballast 422 generates an increasing downward resorting force to counteract the upward lift. Enclosure 436 is a sack that encompasses surface barrier 410. In other words, surface barrier 410 is disposed within the water sack formed by enclosure 436 and enclosure 436 extends over the top of surface barrier 410.

FIG. 4D illustrates a fourth edge protection member 404 including a surface barrier 411, wind barrier 415, a ballast 420, a pass-through 426 through which a tension line 431 extends between the tension frame and the PV array to apply tension directly onto the PV array. Non-slip collars 432 have a size and shape that holds onto tension line 431, but do not pull through pass-through 426. Non-slip collars 432 clamp onto tension line 431 and hold edge protection member 404 in a static offset location relative to the PV array when deployed.

FIG. 4E is a profile illustration of a fifth implementation of an edge protection member 405, in accordance with an embodiment of the disclosure. Edge protection member 405 includes surface barrier 410, wind barrier 415, tension frame connector 425, PV array connector 430, an anchoring system 450. Edge protection member 405 is similar to edge protection member 401 except that the ballast is replaced (or supplemented) by a downward tension on wind barrier 415 by anchoring system 450. Anchoring system 405 includes anchor lines 455 that extend between the bottom of wind barrier 415 and one or more anchors 460. Anchors 460 may be gravity anchors, embedment anchors, or otherwise. Additionally, a tensioning apparatus may be included to maintain downward tension despite elevation changes in water surface 370. A tensioning apparatus may include a pulley coupled to an anchor around which anchor lines 455 are wrapped and connected to a submerged float.

FIG. 4F is a profile illustration of a sixth implementation of an edge protection member 406, in accordance with an embodiment of the disclosure. Edge protection member 406 includes surface barrier 410, wind barrier 415, ballast 420, tension frame connector 425, PV array connector 430, a sea anchor 470 (also referred to as a drogue anchor). Edge protection member 406 is similar to edge protection member 401 except for the addition of sea anchor 470. Furthermore, ballast 420 may be omitted or incorporated into sea anchor 470. Sea anchor 470 introduces drag into the vertical motion of surface barrier 410. The vertical drag provided by sea anchor 470 lessens the motion of edge protection member 406 in heavy seas/water. This reduced motion helps block larger waves and reduces the likelihood of the waves washing over the top of the PV array. In other words, surface barrier 410 is less likely to ride up over a larger wave, but rather rides through the wave, thereby diminishing its amplitude and potentially blocking or reducing the cresting of large waves onto the PV array.

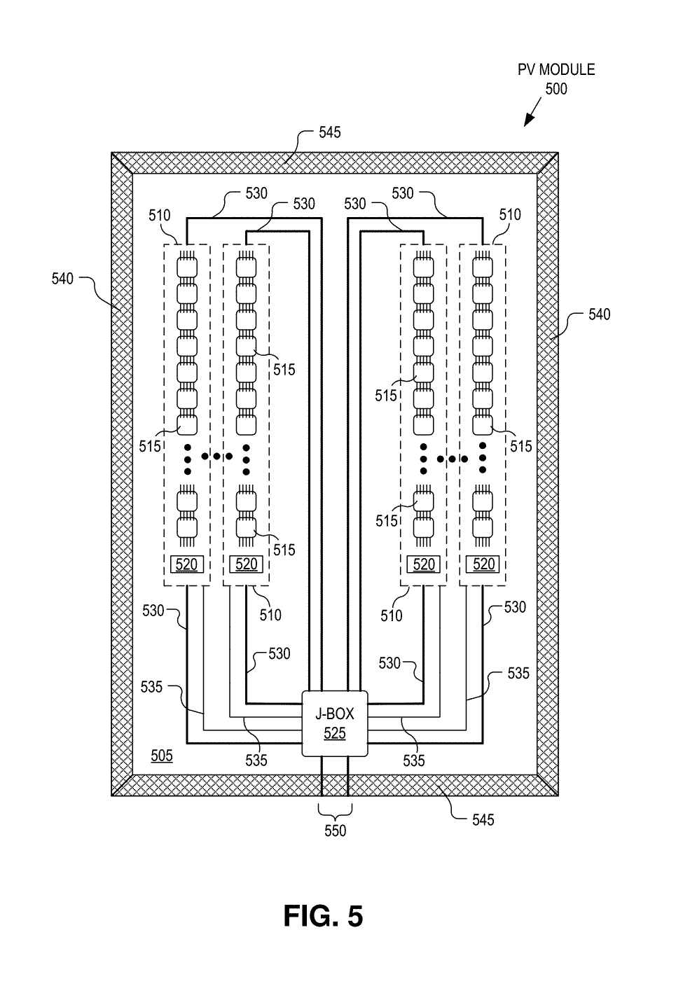

FIG. 5 is an illustration of a photovoltaic (“PV”) module 500, in accordance with an embodiment of the disclosure. PV module 500 is one possible implementation of PV modules 140 illustrated in FIG. 1. The illustrated embodiment of PV module 500 includes laminated support structure 505, solar cell strings 510 including solar cells 515, distributed circuitry 520, a junction box 525, power lines 530, signal lines 535, side edge treatments 540, end edge treatments 545, and output ports 550. In other embodiments, PV module 500 may be a rigid solar panel disposed over a flotation apparatus.

Solar cell strings 510 each includes a plurality of solar cells 515 electrically connected in series and/or parallel to generate solar power and a current in response to light incident upon a frontside of PV module 500. PV module 500 may include any number of solar cell strings 510 each having any number of solar cells 515. However, PV module 500 is well-suited for generating kilowatts of power and may be coupled with additional instances of PV module 500 for generating megawatts of power. For example, each solar cell 515 may be designed to output 10 A @ 1V, each solar cell string 510 may include between 50 and 1000 series connected solar cells 515 to generate 10 A @ 1000V on output ports 550. Of course, the actual number of solar cell strings 510, number of solar cells 515 per solar cell string 510, amperage and voltage output may be selected by design and vary outside the above demonstrative ranges and/or that illustrated in FIG. 5. PV module 500 may be referred to as a “macro” module to indicate that the design of PV module 500 is well-suited for integrating large numbers (e.g., 100's or 1000's) of solar cells 515 into a single contiguous module or form factor for commercial scale power generation. However, it is also anticipated that the designs disclosed herein are also applicable to sub-kilowatt power generation applications.

In the illustrated embodiment, PV module 500 encases solar cell strings 510 within laminated support structure 505. Laminated support structure 505 is fabricated as a multi-layer laminated structure that is durable, environmentally benign/inert, and relatively low cost when compared to conventional commercial grade solar power generating systems that include rigid housings and bulky support structures. Laminated support structure 505 is a mat-like protective encasement that surrounds solar cell strings 510 and is compliant to rolling or folding. By embedding solar cell strings 510 in a laminated structure, expensive frames and mechanical support infrastructures can be avoided thereby facilitating simplified storage and quick deployment in a variety of environmental conditions. For example, PV module 500 may be deployed in horizontal, inclined, or vertical orientations. PV module 500 can be temporarily deployed for short-term power generation (e.g., portable deployments, deployments in the event of unexpected power grid failure, deployments in the event of natural disasters, etc.), seasonal power generation, or long-term/quasi-permanent deployments (e.g., multi-year or multi-decade). PV module 500 can be tailored for deployment over land or water bodies (e.g., water reservoirs as discussed herein).

In one embodiment, solar cells 515 are fabricated of monocrystalline silicon; however, in other embodiments, solar cells 515 may be implemented using polycrystalline silicon, thin film technologies, other semiconductor materials (e.g., gallium arsenide), or other solar cell technologies. The illustrated embodiment of each solar cell string 510 includes a plurality of solar cells 515 coupled in series. In other embodiments, solar cell strings 510 may also include a group of parallel coupled solar cells 515 that are coupled in series with other parallel coupled solar cells 515. Furthermore, the physical layout of these series coupled solar cells 515 may assume a variety of different patterns and routes. For example, a given solar cell string 510 may follow a straight path, a zigzag or serpentine path, a curved path, a spiral path, or trace out any number of a geometric patterns (e.g., concentric rectangles, etc.).

In the illustrated embodiment, power lines 530 electrically connect solar cell strings 510 to power circuitry within junction box 525. Junction box 525 includes the centralized circuitry for managing operations of solar cell strings 510, collecting the solar power or current generated by solar cell strings 510, and outputting the solar power via output ports. In the illustrated embodiment, junction box 525 is a single enclosure that includes both power electronics, communication electronics, sensors, and control logic for PV module 500. In one embodiment, junction box 525 is a hermetically sealed enclosure that dissipates heat to its surrounding environment. In other embodiments, junction box 525 may represent multiple interconnected physical enclosures. Junction box 525 may be integrated into laminated support structure 505, mounted on a frontside, backside, or both sides of laminated support structure 505. In one embodiment, a cutout or hole is made into laminated support structure 505 into which junction box 525 is disposed. In the illustrated embodiment, junction box 525 is disposed proximate to one end of PV module 500, though it may also be mounted along a side edge or other interior location.

In addition to the centralized circuitry incorporated into junction box 525, the illustrated embodiment of PV module 500 also includes distributed circuitry 520 integrated within laminated support structure 505 and disposed throughout PV module 500. Distributed circuitry 520 is coupled to solar cell strings 510 to selectively route current generated by solar cells 515 under the influence and control of a controller within junction box 525. Distributed circuitry 520 may be coupled in various shunting paths across different portions of the various solar cell strings 510 to bypass failing sections of solar cells 515, to discharge and shutdown one or more solar cell strings 510 (or portions thereof), to respond to a failure or short circuit condition sensed within PV module 500, or otherwise. In some embodiments, distributed circuitry 520 includes switches, transistors, or fuses disposed in line with solar cells 515, which can be selectively activated/deactivated (e.g., energized, blown, etc) to open circuit or short circuit sections of solar cell strings 510. Signal lines 535 are routed within laminated support structure 505 to interconnect distributed circuitry 520 to junction box 525. Signal lines 535 may be parallel or serial datapaths, and may include one or more addressing lines, command lines, and/or sensing lines. Although FIG. 5 illustrates signal lines 535 as distinct physical lines, in other embodiments, power line communications or even wireless communications may be used in place of signal lines 535.

Distributed circuitry 520 also serves to increase yield rates for PV modules 500. As mentioned above, PV module 500 may include 100's or even 1000's of solar cells 515. If every solar cell 515 is required to function in order to obtain a functioning PV module 500, the yield rate of PV modules 500 could be unviable for mass production. Accordingly, distributed circuitry 520 includes inline fuses and switches dispersed throughout solar cell strings 510 to actively shunt or otherwise isolate non-functioning solar cells 515, or sections of solar cells 515, from the remaining functioning solar cells 515. By sensing and actively isolating non-functioning solar cells 515 from functioning solar cells 515, yield rates for PV modules 500 can be substantially increased.

PV module 500 includes edge treatments for physically interconnecting and mounting one or more PV modules 500 in a variety of environments to form a contiguous PV array. For example, the illustrated embodiment of PV module 500 includes side edge treatments 540 disposed along side edges of PV module 500 and end edge treatments 545 disposed along the shorter end edges of PV module 500. In other embodiments, side edge treatments 540 may be disposed along the shorter end edges while end edge treatments 545 may be disposed along the longer side edges.

Side edge treatments 540 represent edge connection strips and optional drainage features that facilitate mechanically connecting PV module 500 to other PV modules 500 to form a large PV array when deployed in the field. End edge treatments 545 facilitate mechanical mounting or holding of PV module 500 taut when unfolded or unrolled. Collectively, side edge treatments 540 and end edge treatments 545 facilitate variable size deployments, that can be mechanically and electrically interconnected into a contiguous system and which can be mounted in a variety of orientations (vertical, horizontal, inclined) and environments (e.g., land or water).

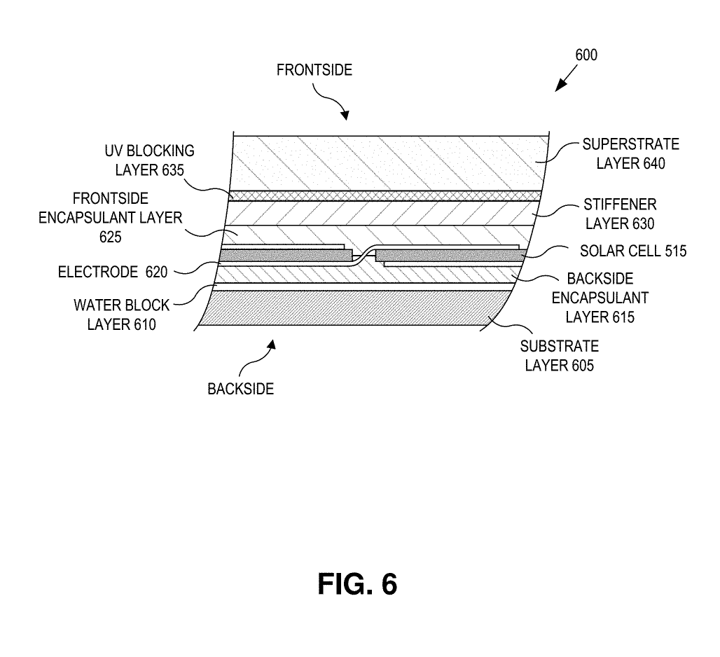

FIG. 6 is a cross-sectional illustration of a demonstrative material stack 600 for implementing laminated support structure 505, in accordance with an embodiment of the disclosure. Material stack 600 is also well suited for deployment in an aqueous environment, such as a water reservoir. The illustrated embodiment of material stack 600 includes a substrate layer 605, a water block layer 610, a backside encapsulant layer 615, a frontside encapsulant layer 625, a stiffener layer 630, an ultraviolet (“UV”) blocking layer 635, and a superstrate layer 640.

Frontside encapsulant layer 625 and backside encapsulant layer 615 sandwich around solar cells 515 which are electrically interconnected front to back and back to front by electrodes 620. Both frontside and backside encapsulant layers 625 and 615 conform to and otherwise mold around solar cells 515. In one embodiment, frontside and backside encapsulant layers 625 and 615 are formed of ethylene-vinyl acetate (EVA) each approximately 0.9 mm thick. In other embodiments, frontside and backside encapsulant layers 625 and 615 are fabricated from layers of polyolefin. In one embodiment, heat and pressure are used to encapsulate solar cells 515 between the frontside and backside encapsulant layers. For example, even pressure may be applied using a vacuum tool, which also serves to eliminate deleterious moisture and air pockets.

Substrate layer 605 provides physical environmental protection to the backside of solar cells 315. In particular, substrate layer 605 protects against damage occurring from physical impacts, animal influence, and other forms of physical intrusions from the backside. In one embodiment, substrate 605 is fabricated of polyethylene terephthalate (PET) approximately 0.27 mm thick. In one embodiment, substrate layer 605 is pigmented black in color.

Water block layer 610 is an optional waterproofing layer that can extend the lifespan of solar cells 515 when the PV module is deployed as a floating module. Water block layer 610 may be fabricated as a metal foil layer, such as aluminum foil, an oxide layer, such as silicon dioxide, or otherwise.

Stiffener layer 630 is a layer that adds stiffness to the PV module to reduce the incidence of fracture of solar cells 515 when the PV module is rolled and further provides mechanical protection. Stiffener layer 630 operates to limit the bend radius. In the illustrated embodiment, stiffener layer 630 is disposed across the top side of solar cells 515. Stiffener layer 630 may be fabricated of a polymer material having the desired stiffness, such as a 0.27 mm thick layer of clear PPE.

In one embodiment, UV blocking layer 635 is also an adhesive that is disposed between superstrate layer 640 and stiffener layer 630 to bond the two layers together. UV blocking layer 635 includes UV filtering characteristics to block or otherwise reduce the amount of harmful UV light that penetrates to the lower layers. UV light can age or otherwise damage the underlying material layers thereby shorting the deployed lifespan of the PV module. In one embodiment, UV blocking layer 605 is a 0.2 mm thick layer of UV blocking EVA encapsulant.

Superstrate layer 640 provides physical environmental protection to the frontside of solar cells 515. In particular, superstrate layer 640 protects against damage occurring from physical impacts, animal influence, and other forms of physical intrusions from the frontside. In one embodiment, superstrate layer 640 is fabricated of a polymer material. For example, in one embodiment, superstrate layer 640 is a 0.2 mm thick layer of a fluoropolymer such as ethylene tetrafluoroethylene (ETFE).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An edge protection member for positioning in a waterbody adjacent to a plurality of photovoltaic (“PV”) modules of a PV array that floats on the waterbody to protect the PV array from external forces, the edge protection member comprising:
a surface barrier to block flotsam on a water surface of the waterbody from floating into the PV array; and
a wind barrier connected to the surface barrier and configured to extend below the water surface when the edge protection member is positioned in the waterbody, wherein the wind barrier creates a windscreen that extends down below the water surface when the surface barrier is lifted off the water surface to reduce an incidence of wind getting under the PV array and lifting portions of the PV array off the waterbody.

2. The edge protection member of claim 1, wherein the surface barrier comprises an elongated float, or a series of elongated floats, for extending an entire length of at least one side of the PV array, wherein the surface barrier has a freeboard that extends above the water surface.

3. The edge protection member of claim 2, wherein the elongated float, or each of the series of elongated floats, comprises an inflatable float, a solid core float, or a rigid body air cavity float.

4. The edge protection member of claim 1, further comprising:
a ballast connected to the wind barrier to aid in keeping at least a portion of the wind barrier below the water surface.

5. The edge protection member of claim 4, wherein the wind barrier comprises a flexible skirt that extends from a bottom side of the surface barrier, and wherein the ballast connects to a bottom side of the flexible skirt.

6. The edge protection member of claim 4, wherein the ballast comprises at least one of a solid core weight, a chain, a cable, concrete, granular fill material, or a water sack.

7. The edge protection member of claim 4, wherein the wind barrier comprises sides of a sack connected to the surface barrier and wherein the ballast comprises the sack for filling with water.

8. The edge protection member of claim 7, wherein the surface barrier is disposed within the sack and wherein the ballast further comprises weight material disposed within the sack.

9. The edge protection member of claim 1, further comprising:
a tension frame connector disposed along the surface barrier for applying outward tension on the edge protection member to pull the edge protection member away from the PV array when deployed in the waterbody; and
a PV array connector disposed along an opposite side of the surface barrier to translate the outward tension to the PV array to also place the PV array under tension when deployed.

10. The edge protection member of claim 9, wherein the PV array connector is flexible and collapses in compression, wherein the PV array connector is wider in a middle portion of the edge protection member than compared to peripheral portions of the edge protection member to provide a larger standoff distance between the surface barrier and the PV array in the middle portion than the peripheral portions.

11. The edge protection member of claim 9, wherein the PV array connector mounts to the surface barrier at a vertical position that substantially does not apply a vertical force on the PV array that lifts the PV array up off the water surface or submerges the PV array down below the water surface.

12. The edge protection member of claim 1, further comprising:
a plurality of pass-throughs extending through the surface barrier to permit tension lines to pass through the surface barrier to apply tension on the PV array; and
a plurality of non-slip collars each having a size and shape that holds onto a tension line and will not pull through the pass-throughs, wherein the non-slip collars hold the edge protection member in a static location relative to the PV array when deployed.

13. The edge protection member of claim 1, further comprising:
longitudinal connectors disposed at distal ends of the surface barrier to apply longitudinal tension to the edge protection member when deployed.

14. A floating photovoltaic (“PV”) power generation system, comprising:
a plurality of PV modules mechanically interconnected into a PV array that floats on a waterbody, the PV array for generating solar power; and
a plurality of edge protection members disposed along multiple sides of the PV array, and offset therefrom, to protect the PV array, each of the edge protection members including:
a surface barrier to block flotsam on a water surface of the waterbody from floating into the PV array and reduce an amplitude of waves washing over the PV array.

15. The PV power generation system of claim 14, wherein each of the edge protection members further comprises:
a wind barrier connected to the surface barrier and extending below the water surface, wherein the wind barrier creates a windscreen that extends down below the water surface when the surface barrier is lifted up from the water surface to reduce an incidence of wind getting under the PV array and lifting portions of the PV array off the waterbody.

16. The PV power generation system of claim 15, wherein the surface barrier comprises an elongated float, or a series of elongated floats, wherein the surface barrier has a freeboard that extends above the water surface.

17. The edge protection member of claim 16, wherein the elongated float, or each of the series of elongated floats, comprises an inflatable float, a solid core float, or a rigid body air cavity float.

18. The PV power generation system of claim 15, wherein the edge protection members extend around all sides of the PV array, the PV power generation system further comprising:
one or more conductors disposed within the edge protection members and extending around the PV array, wherein the one or more conductors are electrically grounded to provide a perimeter guard ring that blocks electrical arcing, in an event of failure, between the PV array and an item external to the edge protection members.

19. The PV power generation system of claim 15, wherein each of the edge protection members further comprises:
a ballast connected to the wind barrier to aid in keeping at least a portion of the wind barrier below the water surface.

20. The PV power generation system of claim 19, wherein the wind barrier comprises a flexible skirt that extends from a bottom side of the surface barrier and the ballast connects to a bottom side of the flexible skirt.

21. The PV power generation system of claim 19, wherein the ballast comprises at least one of a solid core weight, granular fill material, or a water sack.

22. The PV power generation system of claim 19, wherein the wind barrier comprises sides of a sack connected to the surface barrier and wherein the ballast comprises the sack for filling with water.

23. The PV power generation system of claim 22, wherein the surface barrier is disposed within the sack and wherein the ballast further comprises weight material disposed within the sack.

24. The PV power generation system of claim 15, further comprising:
a tension frame disposed around the PV array and coupled to the PV array to keep the PV modules under tension, wherein the edge protection members are disposed between the tension frame and the PV array.

25. The PV power generation system of claim 24, wherein each of the edge protection members further comprises:
a tension frame connector disposed along the surface barrier for coupling to the tension frame to apply outward tension on the edge protection member to pull the edge protection member away from the PV array; and
a PV array connector disposed along an opposite side of the surface barrier to translate the outward tension to the PV array.

26. The PV power generation system of claim 25, wherein the PV array connector is flexible and collapses in compression, wherein the PV array connector is wider in a middle portion of the edge protection member than compared to peripheral portions of the edge protection member to provide a large standoff distance between the surface barrier and the PV array in the middle portion than the peripheral portions.

27. The PV power generation system of claim 25, wherein the PV array connector mounts to the surface barrier at a vertical position that substantially does not apply a vertical force on the PV array that lifts the PV array up off the water surface or submerges the PV array down below the water surface.

28. The PV power generation system of claim 15, further comprising:
a sea anchor coupled to a bottom side of the wind barrier to reduce vertical movements of the surface barrier in heavy seas.
